(19) United States
(12) Patent Application Publication
(10) Pub. No.: US 2003/0154058 A1
(43) Pub. Date: Aug. 14, 2003

(54) Methods and systems for validating translated geometry

(76) Inventor: Bryan F. Keener, Greenville, SC (US)

Correspondence Address: PERKINS COIE LLP, PATENT-SEA, P.O. BOX 1247, SEATTLE, WA, 98111-1247, US

(21) Appl. No.: 09/879,826

(22) Filed: Jun. 11, 2001

(51) Int. Cl. G06F 7/60

(52) U.S. Cl. 703/2

(57) ABSTRACT

Methods and systems for validating translated geometry. In one embodiment, the methods and systems validate a three-dimensional computer model of a part or assembly translated from a primary CAD system to an alternate CAD system. In this embodiment, a Z score is calculated that represents the accuracy of the translated geometry. Calculation of the Z score requires a geometric property of the master model in the primary CAD system and the same geometric property of the translated model in the alternate CAD system. In one embodiment, the geometric property is the volume of the respective models. In another embodiment, the geometric property is the area of the respective models. Once the Z score has been calculated, it is compared to a pre-selected pass/fail criteria to determine whether the translated geometry is sufficiently accurate to use for manufacturing the corresponding part or assembly.

### CROSS-REFERENCE TO RELATED APPLICATION

This application contains subject matter related to the U.S. patent application having Attorney Reference No. 243768071US, entitled “METHODS AND SYSTEMS FOR AUTOMATICALLY TRANSLATING GEOMETRIC DATA” filed concurrently with this application and having a common inventor and a common assignee. This application accordingly incorporates the cited application by reference.

### TECHNICAL FIELD

The described technology relates generally to methods for determining the accuracy of translated geometry, and more particularly, to methods and systems for validating translated three-dimensional computer models.

### BACKGROUND

Today, most mechanical parts and assemblies are designed using computer-aided design (CAD) systems. These systems enable a designer to create a three-dimensional computer model of a part or assembly that can be viewed and manipulated on a computer display screen. The dimensional data for the part or assembly is stored in a computer database, and if the designer so desires, he or she can create a conventional engineering drawing from the computer database complete with the necessary dimensions to manufacture the part or assembly.

Most machined parts are manufactured today using computer numerically controlled (CNC) machines. Some CNC machines (e.g. milling machines) are programmed to machine parts using three-dimensional part data that describes the relevant features of the part. This three-dimensional part data is usually provided using one of two approaches: The first approach is to manually retrieve the part data from a conventional engineering drawing and manually enter this data into the CNC program. The second and more efficient approach is to download the necessary part data directly from a CAD system into the CNC program. This second approach spares the CNC programmer the time and expense of manually retrieving and entering the part data and can help to avoid costly programming errors.

There are a number of different CAD systems currently available and in use today. These include the Unigraphics, AutoCad, ProEngineer, Catia, and Alibre systems, to name a few. Because of the many different CAD systems available, a supplier selected to manufacture a part will often not be using the same CAD system that was originally used to design or develop the part. When this occurs, the original part model, or “master model,” is translated from the designer's CAD system to the supplier's CAD system so the supplier can use the database to make the part. For example, if the designer is using the Unigraphics CAD system and the selected supplier is using the AutoCAD system, then the three-dimensional computer model is translated from the Unigraphics format to the AutoCAD format before the database is used by the supplier to program its CNC machines.

When a computer model is translated from one CAD system to another, dimensional disparities often occur between the master model and the translated model. These dimensional disparities are usually very small; nevertheless, they can be significant enough to result in a finished part that does not fit properly into its subsequent assembly. As a result, if a supplier uses a translated database to program a CNC machine, the possibility exists that the final machined part will not meet its original design intent.

In most instances, the burden of proof that a translated CAD model meets its original design intent is placed on the supplier. This leads many suppliers to carefully check the translated part geometry against nominal part dimensions specified on conventional engineering drawings provided by the designer. This tedious manual operation has a number of drawbacks. First, it only guarantees that those specific dimensions checked match the original model definition. Second, it is a very time-intensive exercise, requiring the supplier to manually check all the critical dimensions for a given part if he or she is to ensure that all the translated geometry matches the original model. In light of these drawbacks, a method for quickly and easily validating translated geometry would be desirable.

### BRIEF DESCRIPTION OF THE DRAWINGS

FIG. 1 is a flow diagram of a method for validating translated geometry in one embodiment.

FIG. 2 is a flow diagram of a routine for calculating a Z score in one embodiment.

FIG. 3 is a diagram illustrating a display description for automatically generating a Z score in one embodiment.

FIG. 4 is a block diagram illustrating components of a geometry validation system in one embodiment.

### DETAILED DESCRIPTION

The following disclosure describes methods and systems for validating translated geometry. “Validating translated geometry” as used herein means verifying that a translated computer model is a sufficiently accurate geometric representation of the master model it was translated from. In one embodiment, the methods and systems validate geometry translated from a primary CAD system to an alternate CAD system. This embodiment could be employed, for example, where a design entity creates a three-dimensional computer model of a part using a primary CAD system and a supplier selected to manufacture the part uses an alternate CAD system. In this scenario, the part model will often be translated from the designer's primary CAD system to the supplier's alternate CAD system before the supplier uses the model to manufacture the part with computer-controlled manufacturing equipment, such as a CNC milling machine. Accordingly, the methods and systems described here can be used to verify that the translated model is sufficiently accurate to ensure that a part machined from the translated geometry will meet the original design intent.

In one embodiment, the method involves obtaining one or more basic geometric properties for the master model from the primary CAD system. Once the part model has been translated to the alternate CAD system, the same basic geometric properties are obtained for the translated model from the alternate CAD system. These basic geometric properties should include at least the part volume or the part area, and can also include the number of part faces, the number of part edges, or the number of solid bodies associated with the part. Most, if not all, conventional CAD systems capable of generating three-dimensional part models have the capability to automatically provide these geometric properties upon entry of an appropriate command by a user. The method includes a mathematical formula that uses either the volume or area properties obtained from the master model and the translated model to calculate a value that represents the dimensional accuracy of the translated model. This resultant value is then compared to a selected pass/fail criteria to determine if the translation from the primary CAD system to the alternate CAD system resulted in a three-dimensional computer model of sufficient accuracy to yield a machined part that meets its original design intent.

Certain embodiments of the methods and systems disclosed will be described in the context of computer-executable instructions executed by a general-purpose computer, such as a personal computer. In one embodiment, for example, computer-executable instructions for validating translated geometry are stored on a computer-readable medium, such as a floppy disk or CD-ROM. In other embodiments, these instructions are stored on a server computer system and accessed via an intranet computer network or the Internet. Because the structures and functions related to computer-executable routines and corresponding computer implementation systems are well known, they have not been shown or described in detail here to avoid unnecessarily obscuring the described embodiments.

Although the following disclosure provides specific details for a thorough understanding of several embodiments of the methods and systems described, one of ordinary skill in the relevant art will understand that these embodiments can be practiced without some of these details. In other instances, it will be understood that the methods and systems disclosed can include additional details without departing from the scope of the described embodiments. Although some embodiments are described in the context of computer models, such as three-dimensional models created using conventional CAD systems, it will be understood that the methods and systems disclosed are suitable for much broader applications, and can be used to validate the accuracy of other geometric translations where both pre- and post-translation geometric properties are ascertainable.

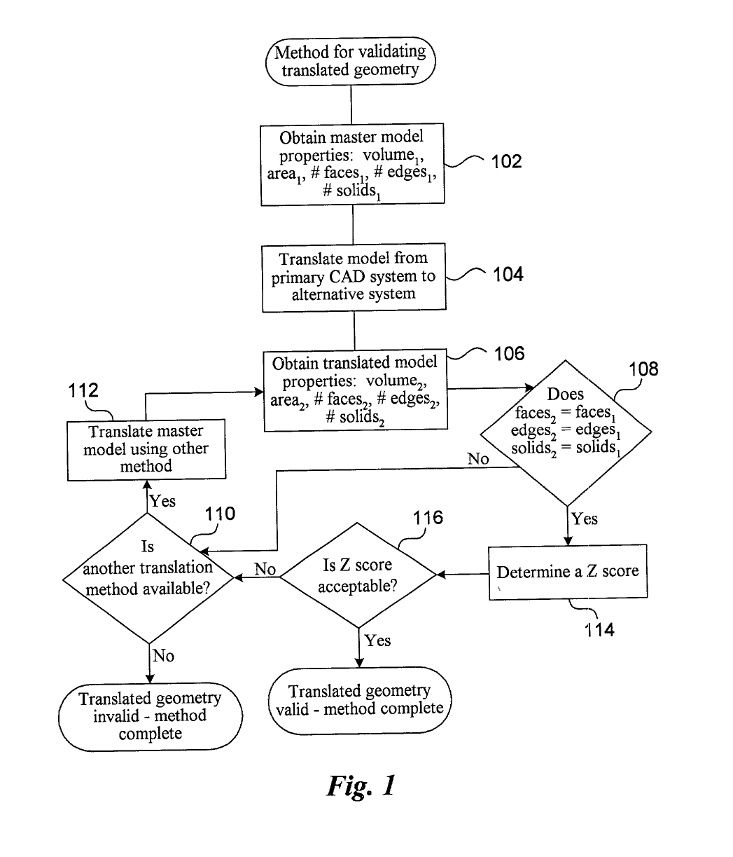

FIG. 1 is a flow diagram of a method 100 for validating translated geometry. In one embodiment, the method 100 validates the geometry of a three-dimensional part model that was originally created in a primary CAD system and then translated to an alternate CAD system. The original part model is referred to here as a “master model” for ease of reference. In an alternate embodiment, the method 100 can be used to validate two-dimensional geometry translated from a first computer system to a second computer system. In yet other embodiments, the method 100 can be used to compare essentially any second geometry to a related first geometry where the requisite properties for both the first and second geometries are obtainable.

In block 102, one or more selected geometric properties are obtained for the master model. These selected properties should include at least a model volume or a model surface area. A number of model faces, a number of model edges, and a number of solid bodies associated with the model can also be obtained if the method is to be performed in accordance with an embodiment explained below. Most, if not all, conventional CAD systems can automatically provide these properties upon input of an appropriate command by a user.

In block 104, the master model is translated from the primary CAD system to an alternate CAD system. As is known, translation in this context means converting a computer-implemented database from a format compatible with the primary CAD system to another format compatible with the alternate CAD system. This model translation can include a number of computer-implemented steps, all of which are known to those of ordinary skill in the relevant art. In block 106, the selected geometric properties previously obtained from the master model in block 102 are now obtained for the translated model. For example, if in one embodiment a volume, area, number of faces, number of edges and number of solid bodies were obtained for the master model from the primary CAD system, then these same properties should now be obtained for the translated model from the alternate CAD system.

In decision block 108, the number of faces, number of edges and number of solids bodies obtained for the translated model are compared to the number of faces, number of edges and number of solid bodies, respectively, obtained for the master model. If these respective numbers are not equivalent, then as a threshold matter, this may indicate that the translated model is of questionable accuracy. Accordingly, in decision block 110, the possibility of implementing a different translation method is investigated. If no other translation method is available, then the translated geometry is deemed questionable because the most basic of geometric properties of the translated model (i.e., the number of faces, number of edges and number of solid bodies) failed to agree with the master model. In one embodiment, an invalid translated geometry such as this can be identified as useable for viewing purposes only, but not for use in manufacturing the corresponding part.

If another translation method is available, then in block 112, the master model is re-translated from the primary CAD system using this other method and the selected geometric properties discussed above are obtained for the re-translated model in block 106. In one embodiment, this other translation method may comprise altering the original model construction in the primary CAD system in an effort to minimize dimensional disparities during translation. For example, the model may have been originally constructed in such a way that features were dimensioned from other features instead of being dimensioned from a common datum plane. When features are dimensioned from other features, dimensional disparities occurring during translation are cumulative. If the model was originally constructed in this way, then it may be possible to re-construct the model so that features are dimensioned from a common datum plane or planes, thereby reducing the tendency for dimensional errors to compound during re-translation of the model. If, in decision block 108, the number of faces, number of edges and number of solid bodies of the re-translated model now agree with the master model, then this threshold test is satisfied and the method 100 continues to block 114.

The check of the number of faces, number of edges and number of solid bodies discussed above and performed in accordance with decision block 108 can be viewed as a cursory or threshold test of the accuracy of the translated geometry. It is a comparison that can be readily made before proceeding. In an alternate embodiment, however, as will be explained below, the number of faces, number of edges and number of solid bodies need not be obtained in blocks 102 or 106 and decision block 108 need not be performed. Instead, the volume and/or the area of the model can be the only geometric properties/property obtained, and the method 100 can proceed directly from block 106 to block 114.

In block 114, a value is determined that represents the accuracy of the model translation from the primary CAD system to the alternate CAD system. In one embodiment, this value is a Z score. The Z score will be recognized by those of ordinary skill in the relevant art as representing the number of standard deviations between a process mean value and a specified process limit. Hence, a relatively high Z score is generally indicative of a process that results in very few defective or defect events. In the context of FIG. 1, however, a relatively high Z score is indicative of a relatively accurate model translation from the primary CAD system to the alternate CAD system.

In decision block 116, the Z score is checked for acceptability. In one embodiment, an acceptable Z score is a Z score that is greater than or equal to a pre-selected pass/fail criteria. This pre-selected pass/fail criteria in one embodiment is a value that represents the minimum Z score necessary such that a part manufactured from the translated model will have a sufficient probability of being within its specified manufacturing tolerances and satisfying its original design intent. Accordingly, if the Z score is found to be acceptable in block 116, then the translated model geometry is deemed valid and the method is complete.

In one embodiment, the selected pass/fail criteria for the Z score is determined using empirical methods. For example, parts and assemblies are usually designed to meet specific dimensional tolerance requirements. These requirements take into account that parts and assemblies cannot be manufactured to their exact nominal design dimensions. The tolerance range for any given part or assembly can be used to establish a corresponding Z score pass/fail criteria as follows: Several models are created at the maximum material condition and at the minimum material condition and the resulting volumes and areas are compared, respectively. Depending on the number of tolerances applied and the complexity of the part or assembly, the resulting volume and area properties will yield an average Z score relative to the nominal design values of these properties. In one embodiment, this empirical method results in a Z score pass/fail criteria of 3.25. In other embodiments, this and other methods can result in other Z score pass/fail criteria depending on the particular manufacturing tolerances associated with the model being translated. In yet other embodiments, analytical methods can be employed in selecting a suitable Z score pass/fail criteria.

Returning to decision block 116, if the calculated Z score does not meet the pre-selected pass/fail criteria, then in decision block 110 another translation method is sought. As explained above, this other translation method may, in one embodiment, comprise dimensional restructuring of the master part model before translation. In other embodiments, this other translation method may comprise translating the master model using a different translation data format. If another translation method is available, then in block 112, this other method is used to re-translate the master model and the selected geometric properties are obtained from the re-translated model in block 106 and examined in decision blocks 108 and 116 as explained above. If another translation method is not available, then the translated model is deemed invalid and the method is complete. Such an invalidated model would be useable for viewing and other purposes but would not be useable for manufacturing of the corresponding part.

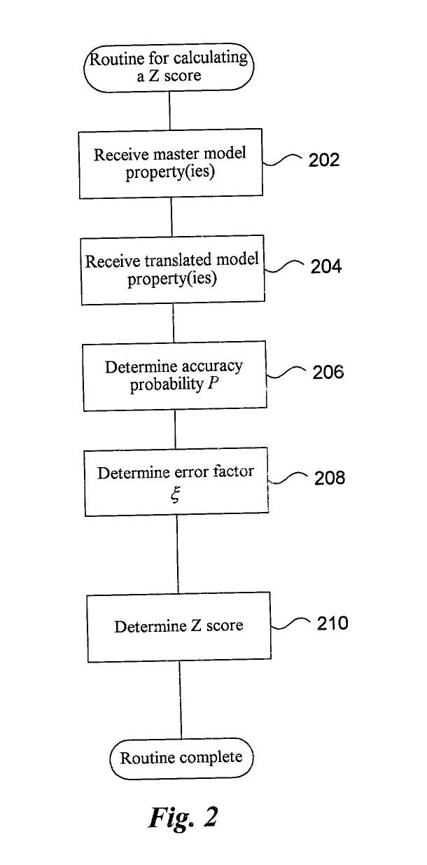

FIG. 2 is a flow diagram of a routine 200 for calculating a Z score in one embodiment. The routine 200 can be implemented in one embodiment on a general-purpose computer, such as a personal computer, following computer-executable instructions stored on a computer-readable medium, such as a CD-ROM or floppy disk. In other embodiments, the routine 200 can be implemented with a system server computer accessed via an intranet computer network or the Internet.

In block 202, the routine receives a master model geometric property. The received master model property can be either a model area or a model volume. In one embodiment, the model volume is used because this property is a cubic term which may result in a Z score that is more accurate than one determined using the model area squared term. In other embodiments, the model area can be used where a squared term can provide the necessary accuracy. As mentioned above, most, if not all, conventional CAD systems capable of producing three-dimensional models can readily provide the user with the model volume or model area upon request. This request often comprises entering a selected keystroke command or selecting a particular icon on a menu display. In block 204, the routine receives a translated model geometric property. The geometric property received in block 204 for the translated model should be the same property that was received in block 202 for the master model. For example, if the volume of the master model was received in block 202, then the volume of the translated model should be received in block 204.

In block 206, the routine determines an Accuracy Probability P. In one embodiment, the Accuracy Probability is defined as the probability that the translated model will be sufficiently accurate to meet its original design intent, or in other words, the probability of no error. In this embodiment, the Accuracy Probability P can be calculated using equation 1 below.

EQN (1): When the translated geometric property is smaller than the corresponding master geometric property, then:

$$P = \frac{Translated property}{Master property}$$

When the translated geometric property is larger than the corresponding master geometric property, then:

$$P = \frac{2 x ( Master property \text{/} Translated property ) - 1}{( Master property \text{/} Translated property )}$$

In block 208, the routine determines the probability of a defect or the Error Factor ξ. In one embodiment, the Error Factor represents the probability that the translated model geometry will fall outside of the specified limits, that is, that the translated model geometry will be insufficiently accurate. The Error Factor can be calculated in this embodiment using the Accuracy Probability P and equation 2 below.

ξ=1−P EQN (2):

In block 210, the routine calculates a Z score using the Error Factor ξ. As described above, the Z score represents the accuracy of the translated model geometry and can be calculated in one embodiment using equation 3 below.

$$EQN ( 3 ) \text{:}$$

$$Z = \sqrt{ln ( \frac{1}{{ξ}^{2}} )} - \frac{2.515517 + 0.802853 \sqrt{ln ( \frac{1}{{ξ}^{2}} )} + 0.010328 {( \sqrt{ln ( \frac{1}{{ξ}^{2}} )} )}^{2}}{1 + 1.432788 \sqrt{ln ( \frac{1}{{ξ}^{2}} )} + 0.189269 {( \sqrt{ln ( \frac{1}{{ξ}^{2}} )} )}^{2} + 0.001308 {( \sqrt{ln ( \frac{1}{{ξ}^{2}} )} )}^{3}}$$

Equation 3 can b e used to evaluate highly nonlinear geometry variations, and is the basis for determining an accurate Z score for geometries that closely match the original design intent but have distinctly small differences in high level model attributes. As discussed above, once a Z score has been determined for the translated model geometry using equation 3, it can be compared to a selected pass/fail criteria to determine if the translated model is sufficiently accurate for use in manufacturing the corresponding part or assembly.

Other methods can be used for approximating a Z score in accordance with the present disclosure given an Accuracy Probability P. One such method, for example, involves using the NORMSINV function available with the known Microsoft Excel Spreadsheet application program. Minitab is another known proprietary application program capable of calculating a Z score. A common shortcoming of using these known application programs to determine a Z score, however, is that as the Accuracy Probability P approaches a number very close to one (which can often happen when translating areas and volumes), such as 0.9999997, these programs provide a Z score which approaches infinity, or is otherwise very high. For example, if the Excel NORMSINV function is used with an Accuracy Probability P of 0.9999996, then it will return a Z score of 5.0664. If a P from 0.9999997 to 0.9999999 inclusive is used, however, the NORMSINV function returns a Z score of 5,000,000.

Very high Z scores often provide little guidance as to the relative accuracy of translated models, especially if two different translation methods are being compared and they both have Accuracy Probabilities P approaching one, and thus both have the same very high Z value. For example, the NORMSINV function provides no distinction between a P of 0.9999997 and a P of 0.9999999 because both have a Z score of 5,000,000. In contrast, one advantage of using equation 3 above to calculate a Z score is that it does not result in very high Z scores as the Accuracy Probability P approaches one. Accordingly, equation 3 offers greater resolution and a better method of determining the relative accuracy of different translation methods.

Yet other methods can be used to approximate a Z score in accordance with the present disclosure given an Accuracy Probability P (or, for that matter, the Error Factor ξ). For example, equation 4 below can be used for this purpose. Equation 4, however, exhibits the same shortcomings discussed above with respect to the EXCEL NORMSINV function, and it is only an approximation.

$$x @ {c 1}_{\text{?}}^{æ} - \frac{1}{2 {z}^{2}} \text{?} \frac{1}{z \sqrt{2 p}} {e}^{- {z}^{2} / 2} \text{?} \\ \text{?} \text{indicates text missing or illegible when filed} \qquad \text{EQN (4)}$$

A Z score can also be derived using Newton's iterations and equation 4 as follows:

Define P=φ(z), and then from equation 4:

$$f ( z ) @ 1 - {{c1}_{\text{?}}}^{æ} - \frac{1}{2 {z}^{2}} \text{?} \frac{1}{z \sqrt{2 p}} {e}^{- {z}^{2} / 2}$$

$$let G ( z ) = f ( z ) - p$$

$$\text{?} \text{indicates text missing or illegible when filed}$$

Substituting the expression of φ(z) into G(z) results in equation 5:

$$\begin{matrix}G ( z ) = 1 - p - {{c1}_{\text{?}}}^{æ} - \frac{1}{2 {z}^{2}} \text{?} \frac{1}{z \sqrt{2 p}} {e}^{- {z}^{2} / 2} \\ = x - {{c1}_{\text{?}}}^{æ} - \frac{1}{2 {z}^{2}} \text{?} \frac{1}{z \sqrt{2 p}} {e}^{- {z}^{2} / 2}\end{matrix} \\ \text{?} \text{indicates text missing or illegible when filed} \qquad \text{EQN (5)}$$

Taking the first derivative of G(z) with respect to z results in:

$$\frac{ⅆ G ( z )}{ⅆ z} = \frac{ⅆ f ( z )}{ⅆ z} = {f}^{′} ( z )$$

Hence, the iteration formula is given by equation 6:

$${Z}_{n + 1} = {Z}_{n} - \frac{G ( {Z}_{n} )}{{f}^{′} ( {Z}_{n} )} n = 0 , 1 , 2 , 3 , 4 , … \qquad \text{EQN (6)}$$

Equation 6 is used for iterations to find the root of G(z). The number of iterations depends on the accuracy predefined by the user. The obtained root value is the Z score. This technique is a long and tedious process for obtaining the Z score, and the method shown by equation 3 above is faster and more accurate.

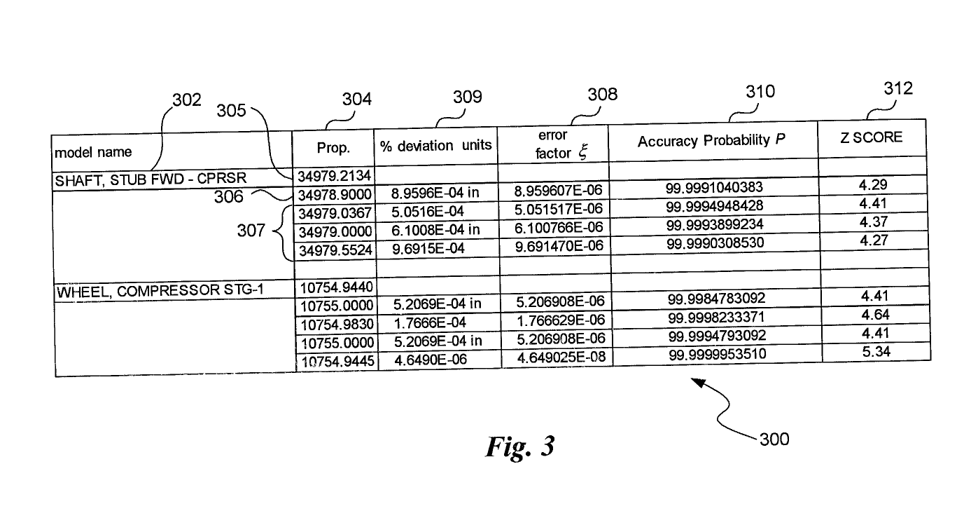

FIG. 3 is a diagram illustrating a display description 300 for automatically generating a Z score in one embodiment. The display description 300 of this embodiment is displayed on a display screen of a general-purpose user computer, such as a typical personal computer. The user enters appropriate information or data in selected fields in the display description 300 to automatically generate a Z score. The display description 300 includes a model name field 302 that receives a name of a part or assembly master model that has been translated from a primary CAD system to an alternate CAD system. A geometric property of the master model is received in a master model property field 305 in a geometric property column 304. If the volume of the master model is entered in field 305, then the Z score will be based on model volume. If, instead, the area of the master model is entered in field 305, then the Z score will be based on model area. As discussed above, the master model geometric property entered in field 305 can be obtained directly from the primary CAD system.

The same geometric property that is entered in field 305 for the master model is entered in a translated model property field 306 for the translated model. For example, if the master model volume was entered in field 305, then the translated model volume is entered in field 306. Similarly, if the master model area was entered in field 305, then the translated model area is entered in field 306. The master model geometric property received in field 305 and the translated model geometric property received in field 306 are used by the display description 300 to determine a Z score. Additional model property fields 307 are included on the display description 300 for entering geometric properties corresponding to additional translated versions of the master model that were translated from the primary CAD system to CAD systems other than the alternate CAD system. For example, in the illustrated embodiment the translated model property shown in field 306 could correspond to a model translated to the ACIS Modeling Kernel, while the properties shown in the fields 307 could correspond to models translated to the AutoCAD system, to the Alibre CAD system, and to the Unigraphics CAD system.

Once a master model property has been entered in the field 305 and a corresponding translated model property is entered in the field 306, a Percentage Deviation is automatically generated in an adjacent field in a column 309. As the name suggests, the Percentage of Deviation is equal to the numerical difference between the magnitude of the master model property and the magnitude of the translated model property as a percentage of the magnitude of the master model property. In one embodiment, the Percentage of Deviation is calculated using equation 7 below.

$$\begin{matrix}\text{EQN (7):} & \\ Percentage deviation = ( \frac{( Translated model prop . ) - ( Master model prop . )}{Master model property} ) \times 100 & \end{matrix}$$

An Error Factor ξ corresponding to the translated model is automatically generated on the display description 300 in a column 308. Equation 2 as described above can be used to calculate the Error Factor in accordance with this embodiment. An Accuracy Probability P is also automatically generated in an adjacent column 310. In one embodiment, the Accuracy Probability can be automatically calculated using equation 1 above.

The display description 300 includes a Z score column 312 for displaying Z scores for translated models. Each Z score displayed in column 312 corresponds to the geometric property shown in the adjacent field in column 304. As explained above, the geometric property can be either model area or model volume. The resulting Z score as displayed in the column 312 can be compared to a pre-selected pass/fail criteria to determine the sufficiency of the translated model. For example, if the pre-selected Z score pass/fail criteria is 3.25, then all of the Z scores shown in column 312 of the illustrated embodiment indicate that the corresponding translated model geometries are sufficiently accurate to meet the original design intent of the master model because they all exceed 3.25. Accordingly, a user can quickly and easily determine the accuracy of a translated model by entering a geometric property of the master model in the property field 305 and by entering the corresponding geometric property of the translated model in a field 306.

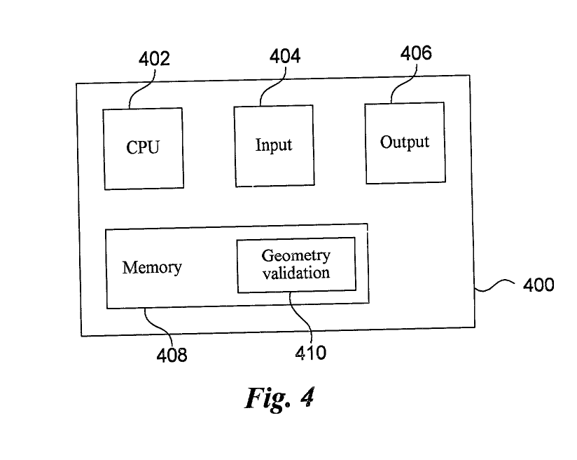

FIG. 4 is a block diagram of a computer system 400 for calculating a Z score in accordance with the methods described above. In one embodiment, the computer system 400 calculates a Z score to determine the accuracy of a three-dimensional computer model translated from a primary CAD system to an alternate CAD system. In one aspect of this embodiment, the Z score is based on the difference between the volume of a master model in the primary CAD system and the volume of the translated model in the alternate CAD system. In another aspect of this embodiment, the Z score is based on the difference between the area of the master model in the primary CAD system and the area of the translated model in the alternate CAD system. Calculation of a Z score using the computer system 400 provides a means for quickly and easily determining whether a translated model is sufficiently accurate to use for manufacturing a selected part or assembly. The computer system 400 includes a central processing unit 402, an input device 404, and an output device 406. The central processing unit 402 can include circuitry for performing computer functions, such as executing software to perform desired calculations and tasks. The input device 404 can include automatic input devices, such as a computer-readable media drive, or manual input devices, such as a keypad or mouse, for inputting data into the central processing unit 402. The output device 406 can include devices coupled to the central processing unit 402, such as a printer or a display screen for presenting display descriptions or other data for a user. The computer system 400 also includes a computer memory 408. The computer memory 408 can include storage media containing computer-executable instructions for performing various tasks and presenting various display descriptions on the output device 406. For example, the computer memory 408 can include a geometry validation component 410 that contains computer-executable instructions for calculating a Z score in accordance with the methods described above.

From the above description it will be appreciated that although various embodiments of the technology have been described for purposes of illustration, numerous modifications may be made without deviating from the spirit or scope of the present disclosure. Accordingly, the present invention is not limited, except by the appended claims.

I claim:

1. A method for determining the dimensional accuracy of a translated three-dimensional computer model relative to a master three-dimensional computer model, the method comprising:
obtaining a master model geometric property, the master model geometric property being a volume or an area of the master model;
obtaining a translated model geometric property, the translated model geometric property being a volume of the translated model when the master model geometric property is the volume of the master model, the translated model geometric property being an area of the translated model when the master model geometric property is the area of the master model;
determining a Z score based on the master model geometric property and the translated model geometric property;
comparing the determined Z score to a pre-selected value;
determining the translated model to be sufficiently dimensionally accurate when the determined Z score is greater than or equal to the pre-selected value; and
determining the translated model to be insufficiently dimensionally accurate when the determined Z score is less than the pre-selected value.

2. The method of claim 1 further comprising:
obtaining a number of master model faces, a number of master model edges and a number of master model solid bodies;
obtaining a number of translated model faces, a number of translated model edges and a number of translated model solid bodies;
comparing the number of translated model faces to the number of master model faces;
comparing the number of translated model edges to the number of master model edges;
comparing the number of translated model solid bodies to the number of master model solid bodies; and
determining a Z score based on the master model geometric property and the translated model geometric property when the number of translated model faces equals the number of master model faces, the number of translated model edges equals the number of master model edges, and the number of translated model solid bodies equals the number of master model solid bodies.

3. The method of claim 1 wherein determining a Z score based on the master model geometric property and the translated model geometric property comprises:
determining an accuracy probability based on the master model geometric property and the translated model geometric property; and
determining an error factor based on the determined accuracy probability.

4. The method of claim 3 wherein determining an accuracy probability includes determining an accuracy probability using an equation that is at least substantially similar to equation (1).

5. The method of claim 3 wherein determining an error factor includes determining an error factor using an equation that is at least substantially similar to equation (2).

6. The method of claim 1 wherein the determined Z score corresponds to a number of standard deviations between a process mean value and a specified process limit.

7. The method of claim 1 wherein the translated three-dimensional computer model is generated by translating the master three-dimensional computer model from a primary CAD system to an alternate CAD system.

8. The method of claim 7 wherein the primary CAD system is a Unigraphics CAD system.

9. The method of claim 1 wherein determining a Z score includes determining a Z score using an equation that is at least substantially similar to equation (3).

10. A method for determining the dimensional accuracy of a second computer model relative to a first computer model, the method comprising:
obtaining a first geometric property of the first computer model;
obtaining a second geometric property of the second computer model; and
determining a Z score based on the first and second geometric properties.

11. The method of claim 10 wherein:
the first geometric property is a volume or an area of the first model;
when the first geometric property is the volume of the first model, the second geometric property is a volume of the second model; and
when the first geometric property is the area of the first model, the second geometric property is an area of the second model.

12. The method of claim 10 wherein the first and second computer models are three-dimensional CAD models.

13. The method of claim 10 further comprising:
comparing the determined Z score to a pre-selected value;
determining the second computer model to be sufficiently dimensionally accurate when the determined Z score is greater than or equal to the pre-selected value; and
determining the second computer model to be insufficiently dimensionally accurate when the determined Z score is less than the pre-selected value.

14. The method of claim 10 wherein determining a Z score based on the first and second geometric properties comprises:
determining an accuracy probability based on the first and second geometric properties; and
determining an error factor based on the determined accuracy probability.

15. The method of claim 14 wherein determining an accuracy probability includes determining an accuracy probability using an equation that is at least substantially similar to equation (1).

16. The method of claim 14 wherein determining an error factor includes determining an error factor using an equation that is at least substantially similar to equation (2).

17. The method of claim 10 wherein the determined Z score corresponds to a number of standard deviations between a process mean value and a specified process limit.

18. The method of claim 10 wherein determining a Z score includes determining a Z score using an equation that is at least substantially similar to equation (3).

19. A method in a computer system for determining the dimensional accuracy of a translated model relative to a master model, the method comprising:
receiving a master model geometric property;
receiving a translated model geometric property;
determining an accuracy probability between the received translated model geometric property and the received master model geometric property;
determining an error factor based on the accuracy probability; and
determining a Z score based on the error factor.

20. The method of claim 19 further comprising:
comparing the determined Z score to a pre-selected value;
when the determined Z score is greater than or equal to the pre-selected value:
determining the translated model to be sufficiently dimensionally accurate; and
when the determined Z score is less than the pre-selected value:
determining the translated model to be insufficiently dimensionally accurate.

21. The method of claim 19 wherein the determined Z score is automatically calculated using an equation that is at least substantially similar to equation (3).

22. The method of claim 19 wherein the determined accuracy probability is automatically calculated using an equation that is at least substantially similar to equation (1).

23. The method of claim 19 wherein the determined error factor is automatically calculated using an equation that is at least substantially similar to equation (2).

24. The method of claim 19 wherein:
the received master model geometric property is a volume of the master model; and
the received translated model geometric property is a volume of the translated model.

25. The method of claim 19 wherein:
the received master model geometric property is an area of the master model; and
the received translated model geometric property is an area of the translated model.

26. The method of claim 19 where in the received translated model geometric property is the same property as the received master model geometric property.

27. A computer-readable medium containing a display description for determining a Z score, the Z score being associated with a translated computer model, the translated computer model being generated by translating a master computer model from a primary computer system to an alternate computer system, the display description comprising:
a master model property field for receiving a master model geometric property;
a translated model property field for receiving a translated model geometric property; and
a Z score field for displaying a Z score that is automatically generated based on the received master model property and the received translated model property.

28. The computer-readable medium of claim 27 wherein the display description further comprises:
a model name field for receiving a name of the master model; and
a percentage of deviation field for displaying a percentage of deviation that is automatically generated based on the received master model property and the received translated model property.

29. The computer-readable medium of claim 27 wherein the display description further comprises:
a percentage of deviation field for displaying a percentage of deviation that is automatically generated based on the received master model property and the received translated model property;
an accuracy probability field for displaying an accuracy probability that is automatically generated based on the received master model property and the received translated model property; and
an error factor field for displaying an error factor that is automatically generated based on the accuracy probability.

30. A computer system for determining the dimensional accuracy of a translated computer model relative to a master computer model, the translated model being generated by translating the master model from a primary computer system to an alternate computer system, the computer system comprising:
means for receiving a master model geometric property, the master model geometric property being a volume or an area of the master model;
means for receiving a translated model geometric property, the translated model geometric property being a volume of the translated model when the master model geometric property is the volume of the master model, the translated model geometric property being an area of the translated model when the master model geometric property is the area of the master model; and
means for determining a Z score based on the master model geometric property and the translated model geometric property.

31. The computer system of claim 30 further comprising:
means for receiving a number of master model faces and a number of master model edges;
means for receiving a number of translated model faces and a number of translated model edges;
means for comparing the number of translated model faces to the number of master model faces; and
means for comparing the number of translated model edges to the number of master model edges.

32. The computer system of claim 30 further comprising means for comparing the determined Z score to a pre-selected value.

33. A computer-readable medium whose contents cause a computer system to determine a Z score, the Z score being associated with a translated computer model generated by translating a master computer model from a primary computer system to an alternate computer system, the Z score being determined by a method comprising:
receiving a master model geometric property;
receiving a translated model geometric property;
determining an accuracy probability based on the received translated model geometric property and the received master model geometric property;
determining an error factor based on the determined accuracy probability; and
determining a Z score based on the determined error factor.

34. The computer-readable medium of claim 33 wherein the determined Z score is calculated using an equation that is at least substantially similar to equation (3).

35. The computer-readable medium of claim 33 wherein the determined accuracy probability is calculated using an equation that is at least substantially similar to equation (1).

36. The computer-readable medium of claim 33 wherein the determined error factor is calculated using an equation that is at least substantially similar to equation (2).

37. The computer-readable medium of claim 33 wherein:
the received master model geometric property is a volume of the master model; and
the received translated model geometric property is a volume of the translated model.

38. The computer-readable medium of claim 33 wherein:
the received master model geometric property is an area of the master model; and
the received translated model geometric property is an area of the translated model.

39. The computer-readable medium of claim 33 wherein the received translated model geometric property is the same property as the received master model geometric property.
